(19) United States
(12) Patent Application Publication
(10) Pub. No.: US 2026/0088025 A1
(43) Pub. Date: Mar. 26, 2026

(54) AUDIO RECOGNITION METHOD AND APPARATUS, DEVICE, STORAGE MEDIUM AND COMPUTER PROGRAM PRODUCT

(71) Applicant: MASHANG CONSUMER FINANCE CO., LTD., Chongqing (CN)

(72) Inventor: Qinglin MENG, Chongqing (CN)

(21) Appl. No.: 19/316,100

(22) Filed: Sep. 2, 2025

(30) Foreign Application Priority Data
Sep. 24, 2024 (CN) 202411338349.6

(51) Int. Cl. G10L 15/18; G10L 15/26

(52) U.S. Cl. CPC G10L 15/1815; G10L 15/26

(57) ABSTRACT

Provided is an audio recognition method. The method includes that audio data is encoded to an audio encoding feature; the audio encoding feature is decoded to a first decoded feature; a preset word text and the first decoded feature are encoded to a first text encoding feature, the first text encoding feature including a feature representing semantics of the preset word text and a feature representing semantics of the audio data; and the first text encoding feature is decoded to a predicted audio text, where the predicted audio text represents the semantics of the preset word text and the semantics of the audio data. An audio recognition apparatus and a storage medium are also provided.

### CROSS-REFERENCE TO RELATED APPLICATION

This application claims priority to Chinese Patent Application No. 202411338349.6 filed on Sep. 24, 2024, the disclosure of which is incorporated herein by reference in its entirety.

### BACKGROUND

Recognition targets of audio recognition methods in related arts often take characters as units. In contrast to hybrid models that use phonemes as modeling units, audio recognition models that use characters as modeling units are more reliant on training data, and semantic information carried by the audio recognition models is more inclined to the training set. When recognizing certain specific words, the audio recognition models using characters as modeling units struggle to recognize those specific words accurately, resulting in poor audio recognition performance.

### SUMMARY

The present disclosure relates to the technical field of natural language processing, and more particularly to an audio recognition method and apparatus, and a storage medium.

Embodiments of the present disclosure provide an audio recognition method and apparatus, and a storage medium, which can improve the audio recognition effect.

The technical solutions of embodiments of the present disclosure are implemented as follows.

The embodiments of the present disclosure provide an audio recognition method. The method includes the following operations.

Audio data is encoded to a first audio encoding feature.

The first audio encoding feature is decoded to a first decoded feature.

A preset word text and the first decoded feature are encoded to a first text encoding feature, where the first text encoding feature includes a feature representing semantics of the preset word text and a feature representing semantics of the audio data.

The first text encoding feature is decoded to obtain a predicted audio text, where the predicted audio text represents the semantics of the preset word text and the semantics of the audio data.

The embodiments of the present disclosure provide an audio recognition apparatus, including a processor, and a memory configured to store computer-executable instructions or computer programs, wherein the processor is configured to execute the computer-executable instructions or computer programs to implement the audio recognition method as described above.

The embodiments of the present disclosure provide a computer-readable storage medium, storing computer programs or computer-executable instructions, where the computer-executable instructions or computer programs, when executed by a processor, implement the audio recognition method as described above.

### BRIEF DESCRIPTION OF THE DRAWINGS

FIG. 1 is a structural diagram of an architecture of an audio recognition system provided by an embodiment of the present disclosure.

FIG. 2 is a structural diagram of an electronic device provided by an embodiment of the present disclosure.

FIG. 3A is a first schematic flowchart of an audio recognition method provided by an embodiment of the present disclosure.

FIG. 3B is a second schematic flowchart of an audio recognition method provided by an embodiment of the present disclosure.

FIG. 3C is a third schematic flowchart of an audio recognition method provided by an embodiment of the present disclosure.

FIG. 3D is a fourth flow diagram of an audio recognition method provided by an embodiment of the present disclosure.

FIG. 3E is a fifth schematic flowchart of an audio recognition method provided by an embodiment of the present disclosure.

FIG. 3F is a sixth schematic flowchart of an audio recognition method provided by an embodiment of the present disclosure.

FIG. 3G is a seventh schematic flowchart of an audio recognition method provided by an embodiment of the present disclosure.

FIG. 3H is an eighth schematic flowchart of an audio recognition method provided by an embodiment of the present disclosure.

FIG. 3I is a ninth schematic flowchart of an audio recognition method provided by an embodiment of the present disclosure.

FIG. 3J is a tenth schematic flowchart of an audio recognition method provided by an embodiment of the present disclosure.

FIG. 3K is an eleventh schematic flowchart of an audio recognition method provided by an embodiment of the present disclosure.

FIG. 4 is a schematic diagram of a software architecture of an audio recognition method in a customer service scenario provided by an embodiment of the present disclosure.

FIG. 5 is a schematic flowchart of an audio recognition method in a scenario of customer service provided by an embodiment of the present disclosure.

FIG. 6A is a schematic diagram of an optional structure of a first audio recognition model provided by an embodiment of the present disclosure.

FIG. 6B is a schematic diagram of an optional structure of a second audio recognition model provided by an embodiment of the present disclosure.

FIG. 6C is a schematic diagram of an optional structure of a third audio recognition model provided by an embodiment of the present disclosure.

FIG. 6D is a schematic diagram of an optional structure of a third audio recognition model during an application phase provided by an embodiment of the present disclosure.

FIG. 6E is a schematic diagram of a principle of encoding and attention-based processing provided by an embodiment of the present disclosure.

It is to be noted that the terms “first” and “second” mentioned above are merely used to distinguish between different solutions and do not represent the quality or priority of the solutions during implementation.

### DETAILED DESCRIPTION

In order to make objectives, technical solutions and advantages of the present disclosure more clear, the present disclosure will be described in further detail below with reference to accompanying drawings, and the described embodiments should not be regarded as limiting the present disclosure, and all other embodiments obtained by those skilled in the art without creative efforts fall within the scope of protection of the present disclosure.

In the following description, reference is made to “some embodiments” that describe a subset of all possible embodiments, but it is to be understood that “some embodiments” may be the same subset or different subsets of all possible embodiments and may be combined with each other without conflict.

In the following description, the terms “first/second/third” are only used to distinguish similar objects, and does not represent any particular ordering of objects. It is to be understood that “first/second/third” may be interchanged in a particular order or priority order where permitted, so that the embodiments of the present disclosure described herein can be implemented in an order other than that illustrated or described herein.

In the embodiments of the present disclosure, the term “module” or “unit” refers to a computer program or a portion thereof that has predetermined functions and works in conjunction with other related parts to achieve predetermined objectives. The “module” or “unit” can be fully or partially implemented using software, hardware (such as processing circuits or memory), or a combination thereof. Similarly, one processor (or multiple processors or memories) can be utilized to implement one or more modules or units. Additionally, each module or unit may be part of an overall module or unit that encompasses the functionality of the module or unit.

Unless otherwise defined, all technical and scientific terms used by the embodiments of the present disclosure have the same meanings as commonly understood by those skilled in the art of the present disclosure. Terms used by the embodiments of the present disclosure are for the purpose of describing embodiments of the present disclosure only and are not intended to limit the present disclosure.

In actual application, the relevant data acquisition and processing in the embodiments of the present disclosure should strictly follow the requirements of applicable national laws and regulations, obtain the informed consent or individual consent of a personal information subject, and carry out subsequent data use and processing within the scope of authorization of the laws and regulations and personal information subjects.

Prior to further detailed description of the embodiments of the present disclosure, the terms and terminology referred to in the embodiments of the present disclosure will be explained, and the terms and terminology are applicable to the following interpretation.
1) End-to-end audio recognition, in which a goal of audio recognition (or speech recognition) is to convert vocabulary content in human speech into text content. End-to-end audio recognition uses pure neural networks instead of traditional hybrid training manners that involve alignment models, acoustic models, language models and the like.
2) Long Short-Term Memory (LSTM), which is a variant of Recurrent Neural Network (RNN), and solves problems such as gradient disappearance and gradient explosion in traditional RNN by introducing a gating mechanism, so that the models can better capture long-term dependencies in sequences.
3) Transformer, which refers to a timing model based on Self-Attention mechanism. Transformer may encode timing information effectively in encoder part, and a processing ability of the Transformer for timing information is far better than that of LSTM, with faster processing speeds. Transformers are widely applied in fields such as natural language processing, computer vision, machine translation, and speech recognition.
4) Convolution-augmented Transformer (Conformer), which refers to a model architecture that combines Transformer and Convolutional Neural Network (CNN). The Transformer model is good at capturing content-based global interactions, and CNN uses local features effectively, allowing the Conformer model to better model both long-term global interaction information and local features.
5) Connectionist Temporal Classification (CTC), which is a commonly used loss function in audio recognition tasks. The basic principle of a CTC loss function is to map continuous audio signals into a sequence of continuous text characters without requiring prior knowledge of word boundaries in the audio. In this way, the task of the model is simplified to predicting the text directly without the need for additional word segmentation operations.
6) Preset word text, which refers to a vocabulary text that is preset for a specific field or specific application scenario. For example, the word text may include proper nouns, high-frequency words, trending words, etc. in the financial field, as well as business terms (such as product names) in financial scenarios, etc.

Recognition targets of audio recognition methods in related arts often take characters as units. In contrast to hybrid models that use phonemes as modeling units, audio recognition models that use characters as modeling units are more reliant on training data, and semantic information carried by the audio recognition models is more inclined to semantic information of a training set. When recognizing certain specific words, the audio recognition models using characters as modeling units struggle to recognize those specific words accurately. Additionally, in the related arts, whether to perform word enhancement of audio text prediction results is determined based on score results output from an acoustic model of audio recognition. This post-processing-based manner has limited capabilities for word enhancement approach and requires searching for homophones or near-homophones in system's output, and thus an operation process is rather cumbersome, resulting in poor audio recognition performance.

In order to solve the above problems, the embodiments of the present disclosure provide an audio recognition method, an apparatus, a device, a computer-readable storage medium, and a computer program product, which can improve an audio recognition effect.

The following describes exemplary applications of the device provided in the embodiments of the present disclosure. The electronic device provided in the embodiments of the present disclosure may be implemented as various types of terminal devices, such as laptops, tablets, desktop computers, set-top boxes, smartphones, smart speakers, smart watches, smart TVs, and in-vehicle terminals, or may also be implemented as servers.

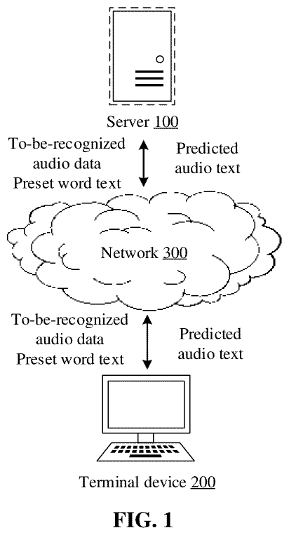

Referring to FIG. 1, FIG. 1 is a structural diagram of an architecture of an audio recognition system provided by an embodiment of the present disclosure. FIG. 1 involves a server 100, a terminal device 200, and a network 300. The terminal device 200 is connected to the server 100 through the network 300, which may be a wide area network or a local area network, or a combination thereof.

In some embodiments, the embodiments of the present disclosure may be implemented by the server and the terminal device in collaboration. For example, the terminal device 200 sends to-be-recognized audio data and a preset word text to the server 100, and the server 100 obtains a predicted audio text by using the audio recognition method provided by the embodiments of the present disclosure, and sends the predicted audio text to the terminal device 200.

In other embodiments, the embodiments of the present disclosure may be implemented separately by a terminal device. The terminal device 200 sends a request to the server 100. The server 100 receives the request and sends a third audio recognition model for performing the audio recognition method provided by the embodiments of the present disclosure to the terminal device 200. The terminal device 200 receives the third audio recognition model sent by the server and downloads the third audio recognition model locally, and obtains a predicted audio result corresponding to the to-be-recognized audio data through the third audio recognition model.

In some embodiments, the terminal device or server may implement the audio recognition method provided by the embodiments of the present disclosure by running various computer-executable instructions or computer programs. For example, the computer-executable instructions may be microprogram-level commands, machine instructions, or software instructions. The computer programs may be native programs or software modules within an operating system. In summary, the above computer-executable instructions may be any form of instructions, the above computer programs may be any form of application programs, modules, or plug-ins, and the terminal device includes but is not limited to mobile phones, computers, intelligent voice interactive device, smart home appliances, vehicle terminals, and the like.

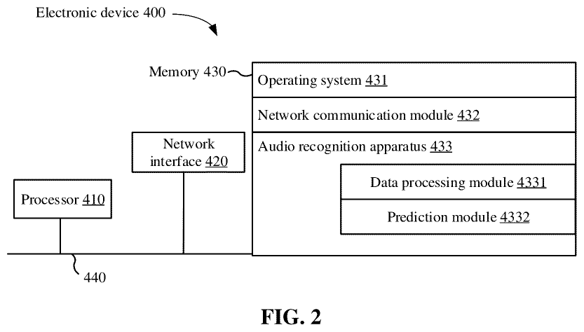

Referring to FIG. 2, FIG. 2 is a structural diagram of an electronic device provided by an embodiment of the present disclosure. The electronic device 400 illustrated in FIG. 2 includes at least one processor 410, a memory 430, and at least one network interface 420. The various components in the electronic device 400 are coupled together via a bus system 440. It can be understood that the bus system 440 is used to implement connection communication among these components. The bus system 440 includes a power bus, a control bus and a status signal bus in addition to a data bus. But for clarity, the various buses are designated as the bus system 440 in FIG. 2.

The processor 410 may be an integrated circuit chip having signal processing capabilities, such as a general-purpose processor, a Digital Signal Processor (DSP), or other programmable logic device, a discrete gate or transistor logic device, a discrete hardware component, or the like. Herein, the general-purpose processor may be a microprocessor or any conventional processor, or the like.

The memory 430 may be removable, non-removable, or a combination thereof. Its exemplary hardware device includes solid state memory, hard disk drives, optical disk drives, and the like. Optionally, the memory 430 includes one or more storage devices physically located remotely from the processor 410.

The memory 430 includes a volatile memory or a non-volatile memory, and may also include both the volatile memory and the non-volatile memory. The non-volatile memory may be a Read Only Memory (ROM), and the volatile memory may be a Random Access Memory (RAM). The memory 430 described in the embodiments of the present disclosure is intended to include any suitable types of memory.

In some embodiments, the memory 430 is capable of storing data to support various operations. Exemplarily, the data include programs, modules, and data structures, or subsets or supersets thereof, as exemplarily illustrated below.

The operating system 431 includes system programs for handling various basic system services and performing hardware-related tasks, such as a framework layer, a core library layer, a driver layer, and the like, which are used for implementing various base services and handling hardware-based tasks.

The network communication module 432 is configured to reach other electronic devices via one or more (wired or wireless) network interfaces 420. Exemplarily, the network interfaces 420 include: Bluetooth, Wireless Compatibility Authentication (WiFi), and Universal Serial Bus (USB), and the like.

In some embodiments, the apparatus provided by the embodiments of the present disclosure may be implemented by software. FIG. 2 illustrates an audio recognition apparatus 433 stored in the memory 430. The audio recognition apparatus 433 may be software in the form of a program and a plug-in, and includes the following software modules: a data processing module 4331 and a prediction module 4332. These modules are logical, so they may be arbitrarily combined or further split according to the implemented functions. The functions of the respective modules will be described below.

In other embodiments, the apparatus provided by the embodiments of the present disclosure may be implemented by hardware. As an example, the apparatus provided by the embodiments of the present disclosure may be a processor in the form of a hardware decoding processor programmed to perform the audio recognition method provided by the embodiments of the present disclosure. For example, the processor in the form of the hardware decoding processor may employ one or more Application Specific Integrated Circuits (ASICs), Digital Signal Processors (DSPs), Programmable Logic Devices (PLDs), Complex Programmable Logic Devices (CPLDs), Field-Programmable Gate Arrays (FPGAs), or other electronic components.

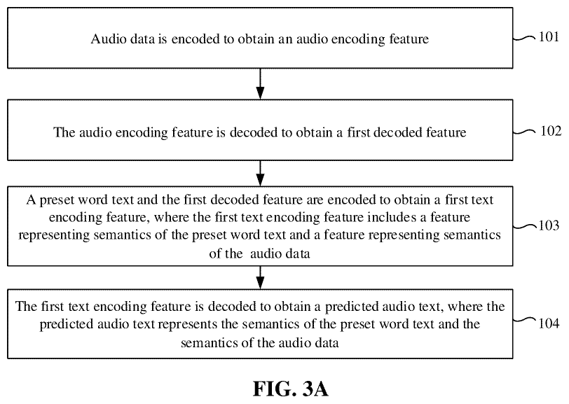

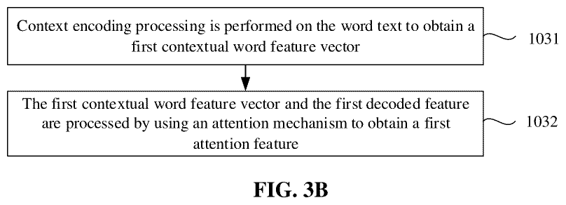

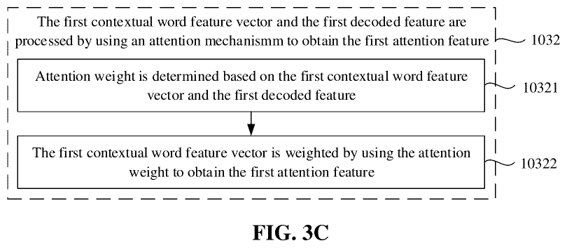

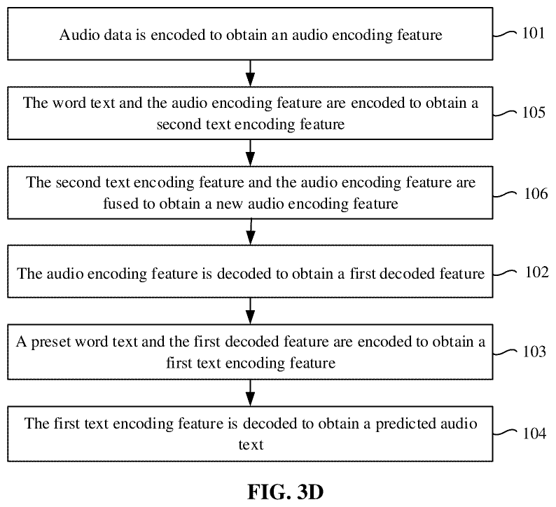

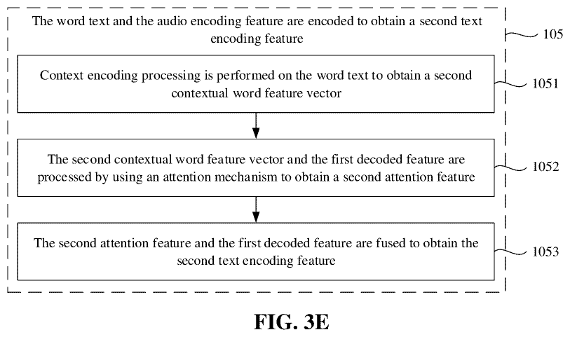

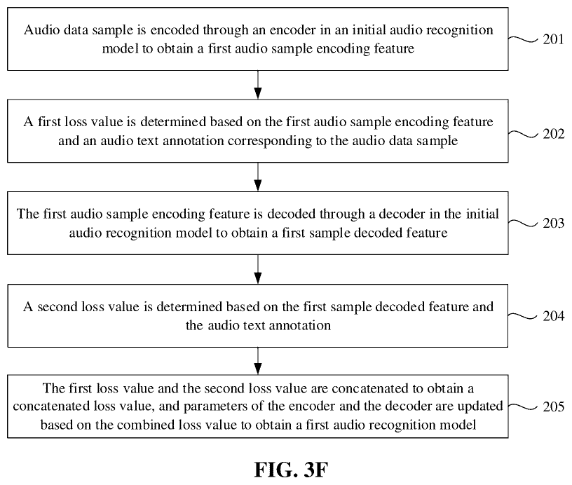

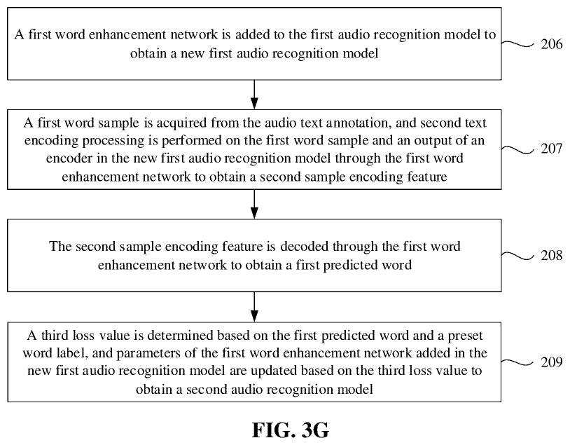

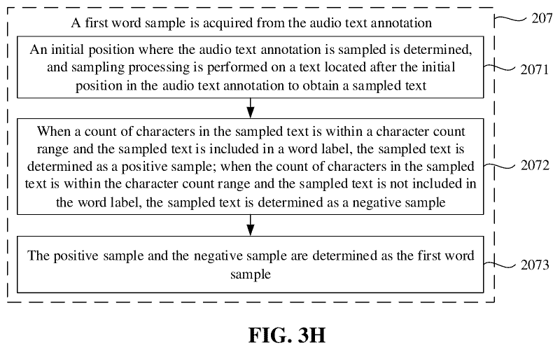

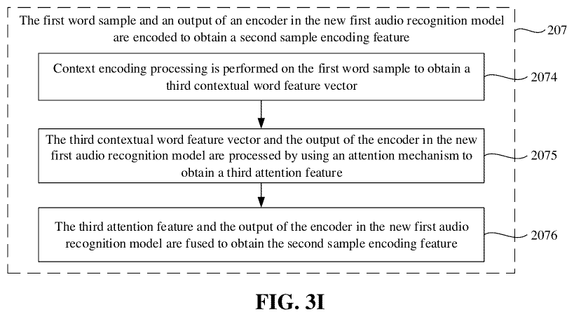

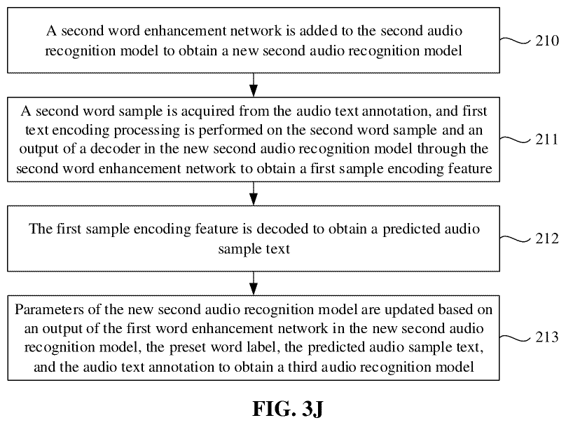

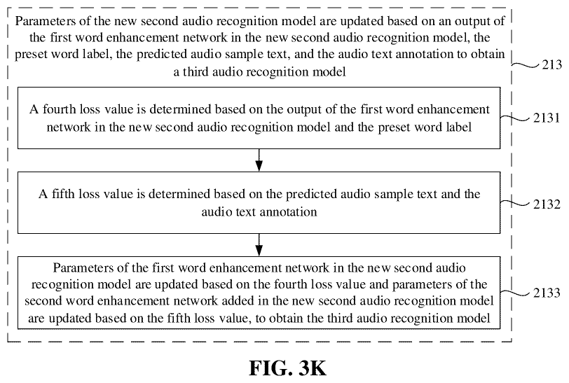

The audio recognition method provided by the embodiments of the present disclosure will be described as below with reference to an exemplary application and implementation of the server provided by the embodiments of the present disclosure by taking the server as an executing entity. Referring to FIG. 3A, FIG. 3A is a first schematic flowchart of an audio recognition method provided by an embodiment of the present disclosure, and explanations will be performed in conjunction with the operations illustrated in FIG. 3A.

At operation 101, audio data is encoded to obtain an audio encoding feature.

In some embodiments, the operation 101 is implemented as follows. Frame segmentation processing is performed on the to-be-recognized audio data to obtain audio frames; frequency domain transformation processing is performed on the audio frames to obtain frequency domain representations of the audio frames; acoustic feature extraction processing is performed on the frequency domain representations to obtain spectrum features; and the spectrum features are encoded to obtain the audio encoding feature.

For example, before the audio data is encoded, the audio data may be preprocessed by such as removing noise, adjusting sampling rate and gain, etc. to ensure audio quality, and frame segmentation is performed on the preprocessed audio data to obtain audio frames with fixed length. Hamming window or Hanning window processing may further be performed on each of the audio frames to reduce spectrum leakage. Frequency domain transformation processing is achieved by performing a Fast Fourier Transform (FFT) on each audio frame to obtain a frequency domain representation. On the basis of the frequency domain representations, Mel-Frequency Cepstral Coefficients (MFCC) or other acoustic features are calculated for acoustic feature extraction to represent spectrum features of the to-be-recognized audio data. The spectrum features are then encoded by an encoder to obtain an audio encoding feature. For instance, the encoder may be constructed based on a Conformer Encoder, which includes components such as convolutional layers, self-attention layers, and feed-forward network layers, to process and transform the spectrum features into audio encoding features. The specific network structure of the encoder is not limited by the embodiments of the present disclosure.

At operation 102, the audio encoding feature is decoded to a first decoded feature.

In some embodiments, the audio encoding feature may be converted into a set of first decoded features by a decoder, the first decoded features include an understanding of the content of the input audio data, and may be used to generate a sequence of predicted audio texts. For example, the input audio encoding feature may be decoded to the first decoded feature by a Transformer Decoder structure, and the decoding processing may be performed by superimposing multiple layers of Transformer Decoder structures. The specific decoder structure is not limited by the embodiments of the present disclosure.

At operation 103, a preset word text and the first decoded feature are encoded to a first text encoding feature, where the first text encoding feature includes a feature representing semantics of the preset word text and a feature representing semantics of the audio data.

In some embodiments, a first attention feature is determined based on the preset word text and the first decoded feature, where the first attention feature represents attention weights for respective words in the preset word text, and for each word in the preset word text, an attention weight of the word is proportional to a probability value of the word being a key word; and the first attention feature and the first decoded feature are fused to obtain the first text encoding feature.

It can be understood that the obtained first decoded feature is “enhanced” at a semantic level by the feature of the semantics of the word text. That is, by highlighting the feature of the key words (corresponding to obtaining the first attention coding feature, where the importance of the words is indicated by the attention weight) from the preset word text, and superimposing the feature of the key words on the first decoded feature (corresponding to the fusion of the first attention feature and the first decoded feature), the “explicit” enhancement of semantics is realized.

In some embodiments, referring to FIG. 3B, the operation that the first attention feature is determined based on the preset word text and the first decoded feature may be implemented by the following operations 1031 and 1032, as described below specifically.

At operation 1031, context encoding processing is performed on the word text to obtain a first contextual word feature vector.

The preset word text refers to a vocabulary text that is preset for a specific field or specific application scenario. For example, the word text may include proper nouns, high-frequency words, trending words, etc. in the financial field, as well as business terms (such as product names) in financial scenarios, etc.

In some embodiments, the operation 1031 may be implemented as follows. Before the context encoding processing, word segmentation processing is performed on the preset word text to obtain input units, or referred to as tokens. A word embedding encoding processing (i.e., Token Embeddings) is performed on the input units to obtain word embedding features. Then, the context encoding processing is performed on the word embedding features to obtain the first contextual word feature vector.

For example, punctuation marks such as spaces, periods, and commas may be used as word segmentation signs to perform word segmentation on the word text, that is, the word text may be segmented into input units. For another example, a third-party word segmentation tool (such as Jieba, NLTK, SpaCy, etc.) may be used to segment the word text, and these tools can achieve accurate Chinese word segmentation and English word segmentation through algorithms and language models. Token Embeddings may be performed on the input units through a word embedding model (such as Word2Vec, GloVe, etc.), and each input unit may be represented as a vector with a fixed length, and multiple vectors formed therefrom may be combined in order into a word embedding feature (i.e., a sequence). The context encoding processing is performed on the word embedding feature through an LSTM network to obtain the first contextual word feature vector.

At operation 1032, the first contextual word feature vector and the first decoded feature are processed by using an attention mechanism, to obtain the first attention feature.

In some embodiments, referring to FIG. 3C, the operation 1032 illustrated in FIG. 3B may be implemented by the following operations 10321 and 10322, as described below specifically.

At operation 10321, an attention weight is determined based on the first contextual word feature vector and the first decoded feature.

In some embodiments, the first decoded feature is used as a Query vector (Q), the first contextual word feature vector is used as a Key vector (K) and a Value vector (V) at the same time, and an attention score is obtained by calculating a dot product of Q and K. Next, the attention score is normalized, for example, by employing a normalization function (such as softmax function) to transform the attention score into a probability distribution as the attention weight.

At operation 10322, the first contextual word feature vector is weighted by using the attention weight to obtain the first attention feature.

In some embodiments, the first contextual word feature vector (corresponding to V above) is weighted by using the attention weight to generate a new feature representation, and the new feature representation may be transformed linearly through a Linear Layer to obtain a rich representation including different positional correlations in the first contextual word feature vector, that is, the first attention feature.

In some embodiments, the operation that the first attention feature and the first decoded feature are fused to obtain the first text encoding feature may be realized as follows. The first attention feature and the first decoded feature are concatenated, and the concatenated feature representation is transformed linearly through the linear layer to obtain the first text encoding feature. For example, the first text encoding feature may be expressed as [first attention feature, first decoded feature].

In other embodiments, a weighted summation processing may be performed on the first attention feature and the first decoded feature by using a preset weight coefficient to obtain the first text encoding feature. The specific implementation for fusing the first attention feature and the first decoded feature are not limited by the embodiments of the present disclosure.

With continued reference to FIG. 3A, at operation 104, the first text encoding feature is decoded to a predicted audio text, where the predicted audio text represents the semantics of the preset word text and the semantics of the audio data.

In some embodiments, the first text encoding feature is decoded to the predicted audio text through a decoding module. For example, the decoding module may be constructed by a Transformer Decoder structure. The decoding processing may be performed by superimposing multiple layers of Transformer Decoder structures. The specific structure of the decoding module is not limited by embodiments of the present disclosure.

For example, the decoding processing may be implemented as follows. Feature mapping processing is performed (for example, feature mapping processing is performed by a softmax function) on the first attention feature in the first text encoding feature to obtain probability values of respective words in the preset word text being key words, and a word with the highest probability value is used as a key word. Decoding processing is performed on the first decoded feature in the first text encoding to obtain the first predicted text. In response to the first predicted text not including the key word, a key word matching processing is performed on the first predicted text based on the key word to obtain a to-be-replaced word in the first predicted text. The to-be-replaced word in the first predicted text is replaced with the key word to obtain a second predicted text, and the second predicted text is used as a predicted audio text.

For example, when the key word is not included in the first predicted text, the key word matching processing may be realized as follows. a fuzzy string matching algorithm (such as Levenshtein distance, Jaccard similarity, Dice coefficient, etc.) is used to recognize words or phrases in the first predicted text that are similar to the key word, serving as the to-be-replaced word. The to-be-replaced word is then replaced with the key word to obtain the second predicted text, which is subsequently used as the predicted audio text. For example, a word “metasoft” in a sentence “Hello, could you please provide your Metasoft account” may be replaced with “Microsoft” from predefined word text, ensuring that a final predicted audio text is more applicable for the business scenario. The method adopted in the key word matching processing is merely illustrative herein, and alternative approaches, such as a thesaurus or word vector models may also be used to recognize semantically similar words or phrases to the key word. The specific key word matching processing method is not limited by the embodiments of the present disclosure.

In other embodiments, the predicted audio text includes a predicted word, which is obtained by decoding the first text encoding feature, and following the above example, the first text encoding feature may be expressed as [first attention feature, first decoded feature]. The first attention feature may be decoded to a predicted word, the first decoded feature may be decoded to a predicted text, and the predicted word and the predicted text are combined to form a predicted audio text. For example, the final output predicted audio text may be expressed as: [XX Company Insurance; Hello, I would like to inquire about services related to XX Company Insurance. Thank you.], where “XX Company Insurance” corresponds to the predicted word, and “Hello, I would like to inquire about services related to XX Company Insurance. Thank you.” corresponds to the predicted text. The predicted word refers to a word obtained by decoding the first attention feature corresponding to the word text, representing a specific word included in the predicted text corresponding to the to-be-recognized audio (which may be understood as selecting a word related to the text content of the to-be-recognized audio from a preset word text). For example, if the word text is [“XX Company Insurance”, “XX Insurance Company”], and the predicted word is “XX Company Insurance”, then it indicates that a specific word “XX Company Insurance” is included in the predicted text corresponding to the to-be-recognized audio. The predicted text refers to the text corresponding to the to-be-recognized audio data that is predicted.

In some embodiments, referring to FIG. 3D, the following operations 105 and 106 may also be performed prior to performing the operation 102 (i.e., decoding the audio encoding feature to the first decoded feature) illustrated in FIG. 3A, as described below specifically.

At operation 105, the word text and the audio encoding feature are encoded to a second text encoding feature.

In some embodiments, referring to FIG. 3E, the operation 105 illustrated in FIG. 3D may be implemented by the following operations 1051 to 1053, as described below specifically.

At operation 1051, a context encoding processing is performed on the word text to obtain a second contextual word feature vector.

A specific implementation of performing the context encoding processing on the word text to obtain the second contextual word feature vector may refer to the descriptions of the operation 1031 above, and will not be repeated here.

At operation 1052, the second contextual word feature vector and the first decoded feature are processed by using an attention mechanism, to obtain the second attention feature.

A specific implementation of processing the second contextual word feature vector and the first decoded feature by using an attention mechanism to obtain the second attention feature may refer to the descriptions of the operation 1032 above, and will not be repeated here.

At operation 1053, the second attention feature and the first decoded feature are fused to obtain the second text encoding feature.

In some embodiments, the second text encoding feature and the audio encoding feature may be concatenated to obtain the second text encoding feature.

In other embodiments, elements of the second text encoding feature and corresponding elements of the audio encoding feature may be added to obtain the second text encoding feature. Optionally, a weighted summation processing may be performed on the second text encoding feature and the audio encoding feature through a preset weight coefficient to obtain the second text encoding feature. The specific implementation manner of fusing the second attention feature and the first decoded feature to obtain the second text encoding feature is not limited by the embodiments of the present disclosure.

Continue to referring to FIG. 3D, at operation 106, the second text encoding feature and the audio encoding feature are fused to obtain a new audio encoding feature.

The new audio encoding feature is used to proceed to operation 102, in which the audio encoding feature is decoded to obtain the first decoded feature.

In some embodiments, the weighted summation processing may be performed on the second text encoding feature and the audio encoding feature according to a preset weight coefficient to obtain the new audio encoding feature, and then the new audio encoding feature is used to proceed to the decoding processing at operation 102 as illustrated in FIG. 3A to obtain the first decoded feature.

In other embodiments, the second text encoding feature and the audio encoding feature may be concatenated, and the concatenated feature may be linearly mapped to obtain the new audio encoding feature. The specific implementation manner of fusing the second text encoding feature and the audio encoding feature to obtain the new audio encoding feature is not limited by the embodiments of the present disclosure.

Through operations 101 to 106, interactions between the preset word text information and the audio data information is implemented in an encoding stage and a decoding stage (corresponding to encoding the preset word text and the first decoded feature and encoding the preset word text and the audio encoding feature), which enhances the understanding of the word text at the semantic level, so that the semantics of the input audio data can be sufficiently characterized in a scenario requiring recognition of a specific word, thereby improving the accuracy of the audio text obtained based on the first text encoding feature.

In some embodiments, referring to FIG. 3F, the audio recognition method provided by the embodiments of the present disclosure is implemented by an audio recognition model, and before the operation 101 (i.e., encoding the audio data to the audio encoding feature) illustrated in FIG. 3A, the following operations 201 to 205 may be further performed, as described below specifically.

At operation 201, an audio data sample is encoded to a first audio sample encoding feature through an encoder in an initial audio recognition model.

In some embodiments, reference of the specific implementation manner of encoding the audio data sample to the first audio sample encoding feature may be made to the description at the operation 101 above. The encoder in the initial audio recognition model may be constructed based on a Conformer Encoder, which includes components such as a convolutional layer, a self-attention layer, and a feed-forward network layer. The specific network structure of the encoder is not limited by the embodiments of the present disclosure.

In some embodiments, the training data for the audio recognition model includes the audio data sample and an audio text representation. For example, an indexing processing is performed on 50,000 hours of speech recognition data (corresponding to the audio data sample) to obtain a text index (corresponding to an audio text annotation) corresponding to each speech, thereby constructing the training data for the audio recognition model.

At operation 202, a first loss value is determined based on the first audio sample encoding feature and an audio text annotation corresponding to the audio data sample.

In some embodiments, the first loss value is calculated based on the first audio sample encoding feature and the audio text annotation corresponding to the audio data sample by a preset first loss function. For example, the first loss function L_{CTC} may be expressed by Equation (1):

$${L}_{CTC} = - log {P}_{CTC} ( y \vert {x}_{E} ) \qquad ( 1 )$$

where y represents the audio text annotation, x_{E} represents the first audio sample encoding feature, P_{CTC} represents a probability of predicting the sequence y under a condition of given x_{E}, which is calculated by a CTC decoder, and −log represents taking a negative logarithm of the probability, so that when the probability is close to 0, a loss value will become very large, which helps to impose greater weight on a false prediction during back propagation.

At operation 203, the first audio sample encoding feature is decoded to a first sample decoded feature through a decoder in the initial audio recognition model.

In some embodiments, reference of the specific implementation manner of decoding the first audio sample encoding feature to the first sample decoded feature may be made to the description of operation 102 above. The decoder in the initial audio recognition model may be constructed by a Transformer Decoder structure. The specific network structure of the decoder is not limited by the embodiments of the present disclosure.

At operation 204, a second loss value is determined based on the first sample decoded feature and the audio text annotation.

In some embodiments, the second loss value is calculated based on the first sample decoded feature and the audio text annotation by a preset second loss function. For example, the second loss function L_{ATT} may be expressed by Equation (2):

$${L}_{ATT} = - log {P}_{ATT} ( y \vert {x}_{D} ) \qquad ( 2 )$$

where y represents the audio text annotation, x_{D} represents the first sample decoded feature, and P_{ATT} represents a probability of predicting the sequence y through an attention mechanism under a condition of given x_{D}.

At operation 205, the first loss value and the second loss value are combined to obtain a combined loss value, and parameters of the encoder and the decoder are updated based on the combined loss value to obtain a first audio recognition model.

In some embodiments, the first loss value and the second loss value are added to obtain the combined loss value, and the parameters of the encoder and the decoder are updated based on the combined loss value to obtain the first audio recognition model. For example, the combined loss value may be expressed by Equation (3):

$${L}_{total} = {L}_{CTC} + {L}_{ATT} \qquad ( 3 )$$

In some embodiments, gradient information is obtained by the combined loss value, and the parameters of the encoder and the decoder are updated according to the gradient information to obtain the first audio recognition model.

For example, the gradient information of the combined loss value for each parameter of the encoder and the decoder is obtained by a back propagation algorithm, and the parameters of the encoder and the decoder are updated using the obtained gradient information according to a gradient descent optimization algorithm (such as batch gradient descent, stochastic gradient descent, etc.). The above process is repeated until a certain number of iterations is reached or the encoder and the decoder converge, thereby obtaining the first audio recognition model.

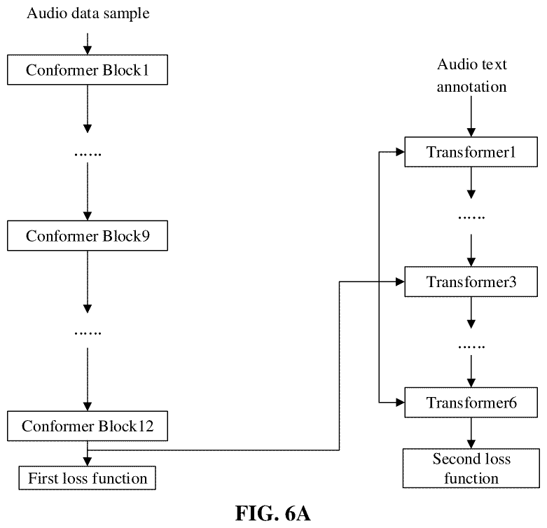

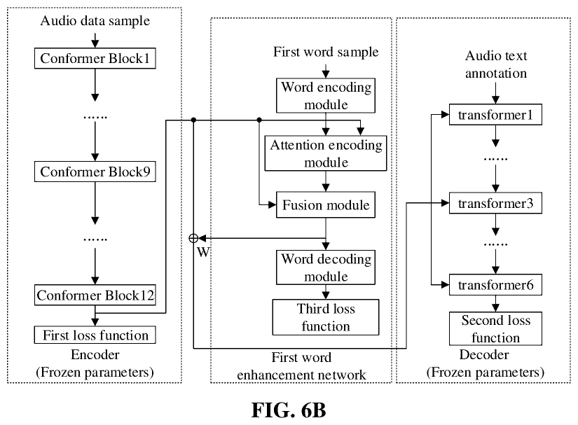

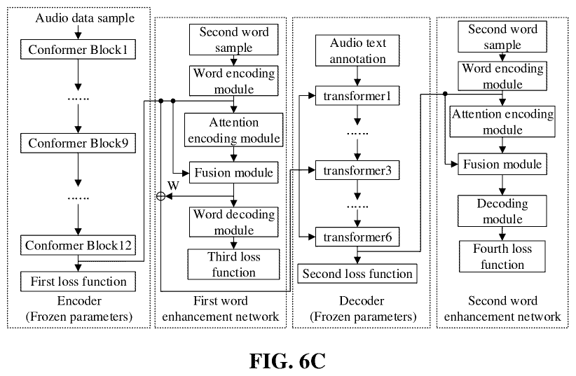

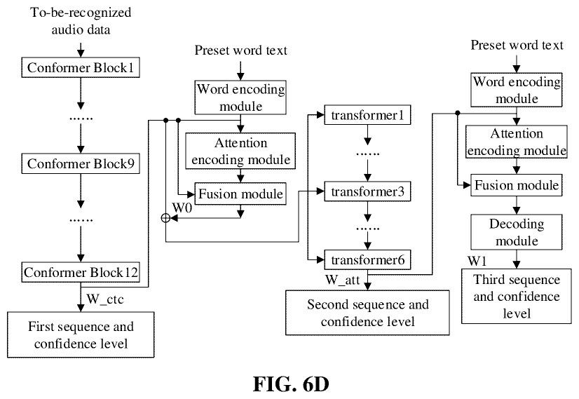

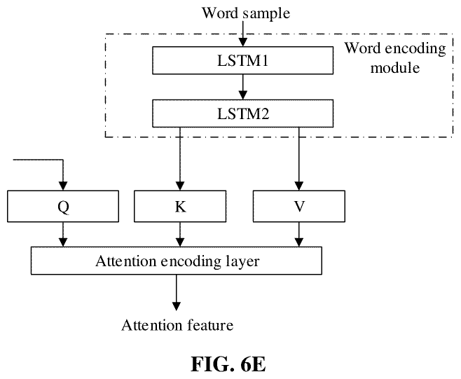

Exemplarily, referring to FIG. 6A, FIG. 6A is a schematic diagram of an optional structure of the first audio recognition model provided by an embodiment of the present disclosure. Conformer Block 1 to Conformer Block 12 illustrated in FIG. 6A constitute the encoder of the first audio recognition model. The first loss value is calculated using the first loss function (corresponding to Equation (1) above), where an output of Conformer Block 12 corresponds to x_{E} in Equation (1). Transformer1 to Transformer6 constitute the decoder of the first audio recognition model. The second loss value is calculated using the second loss function (corresponding to Equation (2) above), where an output of Transformer6 corresponds to x_{D} in Equation (2).

Through operations 201 to 205, training of the base audio recognition model (i.e., first audio recognition model) is realized, and on this basis, a word enhancement network (corresponding to a first word enhancement network and a second word enhancement network below) is further added, so as to improve the recognition ability of the trained audio recognition model for specific words, thereby improving the audio recognition effect.

In some embodiments, referring to FIG. 3G, the following operations 206 to 209 may also be performed after obtaining the first audio recognition model, as described below specifically.

At operation 206, a first word enhancement network is added to the first audio recognition model to obtain a new first audio recognition model.

In some embodiments, referring to FIG. 6B, FIG. 6B is a schematic diagram of an optional structure of a second audio recognition model provided by an embodiment of the present disclosure. The second audio recognition model is obtained by training the new first audio recognition model. In combination with the above descriptions of FIG. 6A, on the basis of FIG. 6A, the first word enhancement network is added after an encoder branch to obtain the new first audio recognition model.

At operation 207, a first word sample is acquired from the audio text annotation, and the first word sample and an output of an encoder in the new first audio recognition model are encoded to a second sample encoding feature through the first word enhancement network.

In some embodiments, referring to FIG. 3H, the acquiring the first word sample from the audio text annotation in the operation 207 illustrated in FIG. 3G may be implemented by the following operations 2071 to 2073, as described below specifically.

At operation 2071, an initial position where the audio text annotation is sampled is determined, and a sampling processing is performed on a text located after the initial position in the audio text annotation to obtain a sampled text.

In some embodiments, the initial position where the audio text annotation is sampled is obtained randomly, and the sampling processing is performed on the text(s) located after the initial position in the audio text annotation based on the initial position to obtain the sampled text(s). For example, a length is obtained by len (text), where text represents the audio text annotation, and the initial position may be expressed as char_begin_index=random.choice (0, length−char_count−1), where length represents a text length of the audio text annotation, char_count represents a count of the sampled characters, and random.choice represents a random selection processing.

At operation 2072, when a count of characters in the sampled text is within a character count range and the sampled text is included in a word label, the sampled text is determined as a positive sample; when the count of characters in the sampled text is within the character count range and the sampled text is not included in the word label, the sampled text is determined as a negative sample.

In some embodiments, the character count range is obtained randomly. For example, the character count range may be represented as char_count=random.choice (2, 8), where random.choice represents the random selection processing, meaning that sampled characters are selected randomly within a count range of 2 to 8 characters to obtain the sampled text. When the sampled text obtained through sampling is included in predefined word labels, the sampled text is the positive sample; otherwise, the sampled text is a negative sample. The word label is used to represent specific words in the audio text annotation herein, such as high-frequency words, professional terms, trending words, etc., that appear in the audio text annotation.

At operation 2073, the positive sample and the negative sample are determined as the first word sample.

In some embodiments, the positive sample and the negative sample are combined into the first word sample, and a ratio of the number of positive samples and negative samples may be set empirically according to a specific training task herein. The specific number of the positive samples and the negative samples in the first word sample is not limited by the embodiments of the present disclosure.

For example, the operations 2071 to 2073 may be implemented as follows:
1) audio text annotations of each training batch are traversed;
2) the text length of each audio text annotation is acquired, and the text length is added to a text length table: label_length_list;
3) audio text annotations of the current training batch are traversed, and then a starting index where extraction of characters starts and the number of characters to be extracted are selected randomly, and values of the both are range values selected randomly;
4) characters are extracted according to the range values in 3), and added to the first word sample. When adding the extracted word, it is determined whether the extracted word is included in the word label of this training batch, and if it is not included (i.e., the currently extracted word is a negative sample), adding is stopped when the number of samples in the first word sample exceeds a first preset value (for example, 32); If it is included (that is, the currently extracted word is a positive sample), the currently extracted word is directly added to the first word sample until the number of positive samples in the first word sample of the training batch is greater than or equal to the second preset value (for example, 3). Herein, the word label of the current training batch may be obtained by manual labeling or by key word extraction or the like, and the obtaining manner of the word label is not limited by the embodiments of the present disclosure.

In some embodiments, referring to FIG. 3I, the encoding the first word sample and the output of the encoder in the new first audio recognition model to obtain the second sample encoding feature in the operation 207 illustrated in FIG. 3G may be implemented by the following operations 2074 to 2076, as described below specifically.

At operation 2074, a context encoding processing is performed on the first word sample to obtain a third contextual word feature vector.

In some embodiments, referring to FIG. 6B, the context encoding processing may be performed on the first word sample by a word encoding module in the first word enhancement network to obtain the third contextual word feature vector, and reference of the specific implementation thereof may be made to be described at operation 1031 above, and will not be repeated here.

At operation 2075, the third contextual word feature vector and the output of the encoder in the new first audio recognition model are processed by using an attention mechanism, to obtain a third attention feature.

In some embodiments, referring to FIG. 6B, the third contextual word feature vector and the second audio sample encoding feature are processed by using an attention mechanism through an attention encoding module within the first word enhancement network, to obtain the third attention feature. Referring to FIG. 6E, FIG. 6E is a schematic diagram of a principle of encoding and attention-based processing provided by an embodiment of the present disclosure. The contextual encoding processing is performed on a word sample (corresponding to the first word sample) through a word encoding module composed of two layers of LSTM networks to obtain the third contextual word feature vector. The third contextual word feature vector is then used as K and V and input to an attention encoding layer. The output (corresponding to the output of Conformer Block 12 in FIG. 6B) of the encoder in the new first audio recognition model is used as Q and input to the attention encoding layer to determine an attention weigh. The third contextual word feature vector is then weighted using the attention weight to obtain the third attention feature. A specific implementation manner of the encoding and attention-based processing may refer to the description at operation 1032 above. The obtaining manner of the output of the encoder in the new first audio recognition model may refer to the description at operation 201 above.

At operation 2076, the third attention feature and the output of the encoder in the new first audio recognition model are fused to obtain the second sample encoding feature.

In some embodiments, referring to FIG. 6B, the third attention feature (corresponding to the output of the attention encoding module in the first word enhancement network illustrated in FIG. 6B) and the output (corresponding to the output of the Conformer Block 12 in the encoder illustrated in FIG. 6B) of the encoder in the new first audio recognition model may be concatenated by a fusion module in the first word enhancement network to obtain the second sample encoding feature.

With continued reference to FIG. 3G, at operation 208, the second sample encoding feature is decoded to a first predicted word through the first word enhancement network.

In some embodiments, referring to FIG. 6B, the second sample encoding feature may be decoded through a word decoding module in the first word enhancement network, to obtain the first predicted word. For example, the word decoding module may be constructed based on a Transformer Decoder structure (such as stacking multiple layers of Transformer Decoders for decoding), and the word decoding module may only be used in the training stage. The specific structure of the word decoding module is not limited by the embodiments of the present disclosure.

At operation 209, a third loss value is determined based on the first predicted word and the preset word label, and parameters of the first word enhancement network added in the new first audio recognition model are updated based on the third loss value to obtain a second audio recognition model.

In some embodiments, the third loss value is calculated by using a preset third loss function based on the first predicted word and the preset word label. For instance, the CTC loss function (which may refer to the explanation of Equation (1) above, where the first predicted word corresponds to the first audio sample encoding feature in Equation (1), and the word label corresponds to the audio text annotation in Equation (1)) is used to obtain a difference value (i.e., third loss value) between the first predicted word and the word label. Gradient information of each parameter of the first word enhancement network corresponding to the third loss value is acquired through a back propagation algorithm. Based on gradient descent optimization algorithms (such as batch gradient descent, stochastic gradient descent, etc.), the obtained gradient information is used to update the parameters of the first word enhancement network. This process is repeated until a certain number of iterations is reached or the first word enhancement network converges, thereby obtaining the second audio recognition model. During the parameter updating process, the parameters of the encoder and decoder are frozen.

Through operations 206 to 209, it is realized that on the basis of the first audio recognition model, the first word enhancement network is added after the encoder branch, so that the feature output by the encoder and the feature of the first word sample obtained by the first word enhancement network are fused interactively. For example, during the encoding stage, implicit enhancement for the word sample in the audio recognition process is achieved through the attention encoding module of the first word enhancement network. Since the encoder and decoder are frozen during the training process, the parameters of the encoder and decoder remain unaffected, allowing that the first word enhancement network is adapted to parameters of the basic model (i.e., the first audio recognition model), thereby achieving implicit word sample enhancement without impacting the first audio recognition model.

In some embodiments, referring to FIG. 3J, the following operations 210 to 213 may also be performed after obtaining the second audio recognition model, as described below specifically.

At operation 210, a second word enhancement network is added to the second audio recognition model to obtain a new second audio recognition model.

In some embodiments, referring to FIG. 6C, FIG. 6C is a schematic diagram of an optional structure of a third audio recognition model provided by an embodiment of the present disclosure. The third audio recognition model is obtained by training the new second audio recognition model. Combining with the explanation of FIG. 6B above, on the basis of FIG. 6B, the second word enhancement network is added after the decoder branch to obtain the new second audio recognition model. It is to be noted that the audio data sample used in the training stage corresponding to operations 210 to 213 may be the same as or different from those used in the training stage corresponding to operations 201 to 205 and the training stage corresponding to operations 206 to 209. The audio data samples used in these three training stages are not limited by the embodiments of the present disclosure.

At operation 211, a second word sample is acquired from the audio text annotation, and the second word sample and an output of a decoder in the new second audio recognition model are encoded to a first sample encoding feature through the second word enhancement network.

In some embodiments, the specific implementation manner for acquiring the second word sample from the audio text annotation may refer to the description of operations 2071 to 2073 above. Referring to FIG. 6C, the contextual encoding processing is performed on the second word sample by a word encoding module in the second word enhancement network. The results of the contextual encoding processing (i.e., the output of the word encoding module) are then used as K and V and input to the attention encoding module. The output of the decoder (corresponding to the output of Transformer6 in FIG. 6C) is used as Q and input to the attention encoding module. The output of the attention encoding module and the output of the decoder are then concatenated through a fusion module to obtain the first sample encoding feature. The contextual encoding processing of the word encoding module herein may refer to the description of operation 1031 above, and the attention-based processing of the attention encoding module may refer to the description of operation 1032 above, and will not be repeated here.

Referring to FIG. 6C, a weighted summation processing is performed on the feature (which has the same acquisition manner as that of the second sample encoding feature at operation 2076) output by the fusion module in the first word enhancement network and the feature (which has the same acquisition manner as that of the first audio sample encoding feature at operation 201) output by the encoder by using a preset weight coefficient (corresponding to W illustrated in the first word enhancement network in FIG. 6C). Then, the result therefrom is input to the decoder to obtain the output of the decoder in the new second audio recognition model.

At operation 212, the first sample encoding feature is decoded to a predicted audio sample text.

In some embodiments, referring to FIG. 6C, the first sample encoding feature may be decoded to the predicted audio sample text by a decoding module in the second word enhancement network, and the specific implementation manner of the decoding processing may be referred to the description of operation 104 above, and will not be repeated here.

At operation 213, parameters of the new second audio recognition model are updated based on an output of a first word enhancement network in the new second audio recognition model, the preset word label, the predicted audio sample text, and the audio text annotation to obtain a third audio recognition model.

In some embodiments, referring to FIG. 3K, the operation 213 illustrated in FIG. 3J may be implemented by the following operations 2131 to 2133, as described below specifically.

At operation 2131, a fourth loss value is determined based on the output of the first word enhancement network in the new second audio recognition model and the preset word label.

In some embodiments, referring to FIG. 6C, the fourth loss value may be determined based on the output of the first word enhancement network in the new second audio recognition model and the preset word label by a preset third loss function. The output of the first word enhancement network refers to a predicted word decoded by the word decoding module. The fourth loss value is determined based on the predicted word and the word label (which is the same as the calculation manner of the third loss value above), and the specific implementation thereof may refer to the descriptions of operations 207 to 209 above, and will not be repeated here.

At operation 2132, a fifth loss value is determined based on the predicted audio sample text and the audio text annotation.

In some embodiments, referring to FIG. 6C, the fifth loss value may be calculated based on the predicted audio sample text and the audio text annotation by a preset fourth loss function. The fourth loss function may adopt attention loss, and the attention loss may refer to the description of Equation (2), where the predicted audio sample text corresponds to the first sample decoded feature in Equation (2). The fourth loss function may also adopt other loss functions, such as a cross-entropy loss function, which is not limited by the embodiments of the present disclosure.

At operation 2133, parameters of the first word enhancement network in the new second audio recognition model are updated based on the fourth loss value and parameters of the second word enhancement network added in the new second audio recognition model are updated based on the fifth loss value, to obtain the third audio recognition model.

In some embodiments, gradient information of the fourth loss value for each parameter of the first word enhancement network and gradient information of the fifth loss value for each parameter of the second word enhancement network are obtained by a back propagation algorithm, parameters of the first word enhancement network and the second word enhancement network are updated using the obtained gradient information according to a gradient descent optimization algorithm (such as batch gradient descent, stochastic gradient descent, etc.). The above process is repeated until a certain number of iterations is reached or the first word enhancement network and the second word enhancement network converge, thereby obtaining the third audio recognition model. During the parameter updating process, the parameters of the encoder and decoder are frozen.

Through operations 210 to 213, it is realized that on the basis of the second audio recognition model, the second word enhancement network is added after the decoder branch, so that the feature output by the decoder and the feature of the second word sample obtained by the second word enhancement network are fused interactively. For instance, during the decoding stage, explicit enhancement of the word sample in the audio recognition process is achieved through the attention encoding module of the second word enhancement network. During the training process, the encoder and decoder are frozen, allowing only the first word enhancement network and second word enhancement network to update their parameters. The purpose of updating parameters of the second word enhancement network is to acquire more information of the word sample during the decoding stage, thereby enhancing interaction ability between word information and audio information. The purpose of updating the parameters of the first word enhancement network is to make the first word enhancement network more applicable to parameter changes in the second word enhancement network, thereby achieving improved performance. During training, a learning rate may be reduced (e.g., adjusted to one-fifth of a learning rate used in the training stage corresponding to operations 206 to 209) to prevent parameters of the first word enhancement network from being changed drastically, which could affect the final audio recognition effect.

Through operations 201 to 213, a multi-stage training process is realized, and by adding the first word enhancement network and the second word enhancement network in stages on the basis of the first audio recognition model obtained by training, the interaction ability of the information of the word sample and the information of the audio data is enhanced, so that the third audio recognition model obtained by training has better word recall ability than the first audio recognition model and the second audio recognition model, and thus the audio recognition effect is further improved when specific words need to be recognized.

The audio recognition method provided by the embodiments of the present disclosure may be applied to various scenarios in which audio recognition is required, some of which include: (1) customer service, for example, for processing call center services, realizing conversion of voice audio to text, recording customer service conversations for intelligent response, and the like; (2) media and entertainment, such as generating subtitles automatically, such as movies, TV programs, etc.; (3) barrier-free technologies, such as voice control assisted device, such as wheelchairs, smart homes, etc.; (4) in-vehicle systems, such as in-vehicle audio recognition systems, which are used for navigation, music playback, phone answering, etc.

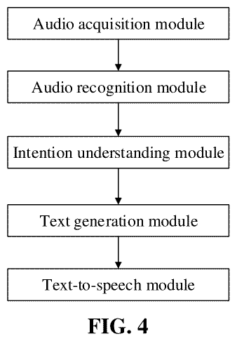

Exemplary applications of the embodiments of the present disclosure in a customer service scenario will be described in the following. Referring to FIG. 4, FIG. 4 is a schematic diagram of software architecture of an audio recognition method in a customer service scenario provided by an embodiment of the present disclosure. An audio acquisition module is used to acquire target audio data, for example, voice stream signals received in real time by a telephone user terminal are received by a Media Resource Control Protocol (MRCP) as the target audio data. An audio recognition module configured to implement the audio recognition method of the embodiments of the present disclosure is used to perform audio recognition on the target audio data to obtain a predicted audio text. An intention understanding module is used to perform intention recognition processing on the predicted audio text to obtain a target intention. A text generation module is used to acquire reply text corresponding to the target intention. A Text-to-Speech (TTS) module is used to perform TTS processing on the reply text to obtain reply audio data, so as to respond to the customer through the reply audio data.

In existing end-to-end speech recognition models, deep-level networks often have stronger generalization capabilities. Recognition targets of end-to-end speech recognition models often take characters as units. In contrast to hybrid models that use phonemes as modeling units, models that use characters as modeling units are more reliant on training data, resulting in the semantic information carried by the models is more inclined to semantic information of a training set. When there are some specific high-frequency words that need to be recognized in the application scenario, they cannot be recognized accurately.

In order to solve the above problems, the embodiments of the present disclosure propose an audio recognition method that effectively utilizes information of an encoder and information of a decoder. The encoder is responsible for implicit modeling, mainly constructing acoustic information and enhancing implicit acoustic information, and the decoder performs explicit modeling. In an inference process, a high-frequency word decoding modeling branch is added, and on the basis of implicit modeling by the Encoder, the information of Decoder is explicitly enhanced at the semantic level.

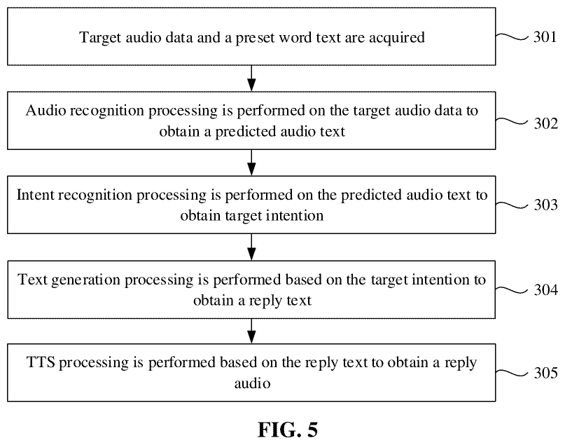

Referring to FIG. 5, FIG. 5 is a schematic flowchart of an audio recognition method in a customer service scenario provided by an embodiment of the present disclosure, as described below specifically.

At operation 301, target audio data and a preset word text are acquired.

In some embodiments, in response to receiving an input operation from a customer, a target audio of the customer is obtained. The preset word text may include words related to businesses corresponding to a current customer. For example, the preset word text is a txt file containing a list of word text contents corresponding to a series of words (such as high-frequency words, trending words, business-specific words, etc.) in this scenario, such as “XX Insurance Product” or the like.

At operation 302, an audio recognition processing is performed on the target audio data to obtain a predicted audio text.

In some embodiments, the target audio data is encoded to an audio encoding feature (such as 80-dimensional Filter Bank (Fbank) feature) (referring to the description of operation 101 above). The audio encoding feature is decoded to a first decoded feature (referring to the description of operation 102 above). The preset word text and the first decoded feature are encoded to the first text encoding feature (referring to the description of operation 103 above). The first text encoding feature is decoded to the predicted audio text (referring to description of operation 104 above).

In some embodiments, the audio recognition processing is performed on the target audio data to obtain the predicted audio text, by using the third audio recognition model obtained by training. Referring to FIG. 6D, FIG. 6D is a schematic diagram of an optional structure of the third audio recognition model in an application stage provided by the embodiment of the present disclosure. In combination with the above description of FIG. 6C, in the application stage of the third audio recognition model, the word decoding module in the first word enhancement network is removed, and other modules remain unchanged.

For example, during a model inference stage, weighted summation may be performed on posterior probability results of respective sequences obtained (i.e., the first sequence, the second sequence, and the third sequence illustrated in FIG. 6D). These weighted posterior probabilities reflect a confidence of the model in each output character at a current time step. An output character with the highest weighted posterior probability is selected as a final predicted text. The first sequence may be obtained by performing CTC mapping on the audio encoding feature (referring to the description of operation 101) of the target audio data. The second sequence may be obtained by decoding and mapping of the first decoded feature (referring to the description at operations 105 to 106) corresponding to the target audio data. The third sequence may be obtained by decoding and mapping of the first character encoding feature (referring to the description at operation 103). The weighted summation of the posterior probability results of the respective sequence obtained may be represented by Equation (4):

$$Score = {W}_{ctc} * {Score}_{ctc} + {W}_{att} * {Score}_{att} + {W}_{1} * {Score}_{words} \qquad ( 4 )$$

where W_{ctc}, Wₐₜₜ, and W₁ correspond to weight coefficients of the first sequence, the second sequence, and the third sequence, respectively, and Score_{ctc}, Scoreₐₜₜ, and Score_{words} correspond to the posterior probability results of the first sequence, the second sequence, and the third sequence, respectively. By adjusting the weight coefficients of decoding of the posterior probabilities, an explicit decoding processing can be more controllable, thereby facilitating the adjustment by the business personnel.

The training of the third audio recognition model may be achieved as follows.

The training dataset is prepared. An index processing is performed on 50,000 hours of pure speech recognition data to obtain a text index (i.e., the above audio text annotation) corresponding to each speech (i.e., the above audio data sample), and the data is used as speech recognition pre-training data.

The above 50,000 hours of speech recognition data is used for training a base speech recognition model (i.e., the first audio recognition model above), and the training only uses a Conformer-Transformer module only. Conformer serves as an Encoder and Transformer serves as a Decoder. During the training process, the output from the Encoder (i.e., the above first audio sample encoding feature) is input into the CTC loss (i.e., the above first loss function), while the output from the Decoder (i.e., the above first sample decoded feature) is input into an Attention loss (i.e., the above second loss function), for summation calculation of losses (i.e., the above combined loss), and multiple rounds of iterations are performed until the losses converge. Then, the model (corresponding to the model structure illustrated in FIG. 6A) is saved.

An input (corresponding to the first word sample and the second word sample above) of the high-frequency word modeling network (i.e. the first word enhancement network and the second word enhancement network above) is data randomly extracted in a label sequence of the speech recognition training set (i.e. the above audio text annotation). The high-frequency words are randomly extracted. An algorithm for extracting the input of the high-frequency word encoding network is designed, as follows.
Input: a speech recognition training data label for each batch;
Output: extracted high-frequency word input data, that is, including randomly extracted positive sample high-frequency word training data (i.e., the above positive sample) and negative sample high-frequency word training data (i.e., the above negative sample).
(1) Label text data in each batch (i.e. the audio text annotation above) is traversed.
(2) The length of each label text data (i.e. the above text length) is added to a label_length_list (i.e., the above text length table);
(3) The batch is traversed, and the number of traverses is all the numbers of batches. Then, a starting index (i.e., the initial position above) where extraction of characters starts and the number of characters to be extracted are selected randomly, and values of the both are range values selected randomly.
(4) According to the range values in (3), characters are extracted and added to a high-frequency word training data table. At the same time of adding, it is determined whether the high-frequency word is included in the speech recognition training data label of this batch. If it is not included (corresponding to the above negative sample), when the number of high-frequency words in the added high-frequency word training data table exceeds the number of samples (i.e., a batch) in a training batch, adding is stopped. If it is included (corresponding to the above positive sample), it is directly added until the correct number of high-frequency words in this batch exceeds the set threshold (such as three).

Regarding implicit high-frequent word training of the Encoder, the base speech recognition model trained in the first training stage is loaded, the Conformer-Transformer structure trained is frozen, and only an implicit high-frequent word network (corresponding to the first word enhancement network illustrated in FIG. 6B) is trained. A high-frequency word encoding network (corresponding to the word encoding module illustrated in FIG. 6B) employs a two-layer LSTM network for high-frequency word vector encoding to obtain high-frequency word encoding vectors. The vectors are inputted together to the high-frequency word network (corresponding to the attention encoding module illustrated in FIG. 6B). The high-frequency word network (i.e., Multi-Head Attention (MHA)) uses an attention mechanism layer. The attention mechanism layer consists of three parts, one is the above acoustic output vector at the encoder, which serves as a query value of the high-frequency word attention mechanism, that is, the value of Q, and other two are Key and Value, where inputs of the Key and Value are the above high-frequency word encoding vectors (that is, the values of K and V above). The output of the high-frequency word network and the vectors output by the Encoder are output to a linear layer together, and then a weighted summation processing is performed on the output of the linear layer and the vectors output by an original Encoder.

The purpose of the training in the above stage is to let the implicit high-frequency word network in Encoder learn information about more high-frequency words. By freezing the Encoder and Decoder networks, the CTC loss and the attention loss, as well as the high-frequency word loss (corresponding to the above third loss function) all participate in the training, so that the implicit high-frequency word network can better adapt to the Encoder and Decoder networks, thus achieving weighting of high-frequency word features, and at the same time, it will not make the implicit high-frequency word network have excessive parameter oscillation in order to better fit high-frequency word, resulting in deterioration of the speech recognition effect.

Here, “implicit” may be understood as enhancement (which is specifically realized by fusing the second attention feature and the first decoded feature, referring to the description of operation 1053 above) at an abstract level of semantic features in the encoding stage (i.e., feature extraction stage) before the final predicted text is output, that is, the semantics (corresponding to the second attention feature and the first decoded feature) of the word text in the encoding stage and the semantics of speech audio (corresponding to the first decoded feature) are fused together as the input of the decoding stage. That is, during the encoding stage, it is “invisible” which word in the preset word text that should be output.

Regarding explicit high-frequency word training of the Decoder, the model (corresponding to the second audio recognition model above) obtained by the above implicit high-frequency word training of the Encoder is loaded. An explicit high-frequency word network (corresponding to the second word enhancement network illustrated in FIG. 6C) connected to the Decoder network is trained. During training, the learning rate is adjusted to one-fifth of the original value, all parameters of Encoder and Decoder networks are kept frozen, and only parameters of two high-frequency word networks are updated. The purpose of updating the parameters of explicit high-frequency word network parameter of Decoder is to make a language modeling module get information about more high-frequency words, thereby enhancing the interaction ability between high-frequency word information and language information. The purpose of updating the parameters of implicit high-frequency word network of Encoder is to make the implicit high-frequency word network more adaptable to the changes of explicit high-frequency word network, so as to get better results. Moreover, the learning rate is reduced, which can prevent parameters of the intermediate implicit high-frequency word network from being changed drastically, thus affecting the audio recognition effect.

Here, “explicit” may be understood that after encoding the preset word text, the first text encoding feature includes the semantics (corresponding to the above first attention feature) of the word text and the semantics (corresponding to the first decoded feature) of the audio data, and in the decoding stage (i.e., the decoding the first text encoding feature to a predicted audio text), the predicted probability of each word in the word text is obtained by mapping the semantics of the word text during decoding, that is, the word with the highest probability is the one that should appear in the final predicted audio text. In this way, which word in the preset word text should be selected for output during decoding is explicitly indicated, so as to obtain the final predicted audio text.

The multi-stage progressive training process can help the models to perform multi-level progressive modeling effectively. In the first stage, training of the base speech recognition model is performed, which can make the models better learn the data of the training set and reduce the influence of high-frequency word data. In the second stage, implicit high-frequency word training of the Encoder is performed, where the base speech recognition model in the first stage is frozen during the training process, so that parameters of the base speech recognition model are not affected, and all the losses in the training process can make the high-frequency word networks adapt to the parameters of the base model, thus achieving enhancement of the implicit high-frequency words without affecting the base speech recognition model. In the third stage, explicit high-frequency word training of Decoder is performed on the basis of the second stage when the parameters of the speech recognition network and the parameters of high-frequency word network are stable, resulting in a stable modeling ability of the models, which makes the explicit decoding training process stable and enhances the training effect of explicit modeling.

Referring to Table 1, Table 1 illustrates the evaluation of a Character Error Rate (CER) of the trained model obtained after training in each stage of multi-stage training:

TABLE 1

| Model | CER |
|---|---|
| First audio recognition model | 15.62 |
| Second audio recognition model | 10.01 |
| Third audio recognition model | 9.63 |

As can be seen from Table 1, on the basis of the first audio recognition model, the third audio recognition model obtained through implicit high-frequency word training of Encoder and explicit high-frequency word training of Decoder has achieved the lowest character error rate, thereby effectively improving the audio recognition effect.

When the above model (corresponding to the third audio recognition model described above) is applied, in the implicit high-frequency word network connected to the Encoder, implicit weighting is performed, and a learning target of the implicit high-frequency word network is a certain high-frequency word (i.e., the above predicted word) instead of a result of speech recognition, and thus a high-frequency word Decoder (corresponding to the word decoding module in the first word enhancement network in FIG. 6C) part of the network is removed, and the output implicit vector and the vector output by the Encoder are used for weighting based on a preset weight (corresponding to W0 illustrated in FIG. 6D), to enhance the high-frequency word information. For the explicit high-frequency word network connected to the Decoder, because a learning target of the network in the training stage is to-be-recognized characters, a “decoder of high-frequency word and sequence” (corresponding to the decoding module in the second word enhancement network in FIG. 6D) is retained, so as to obtain recognized speech sequences and posterior probabilities. Weighted summation processing is performed on the posterior probabilities of respective final sequences according to the above Equation (4) to obtain a final recognition result. In this way, information fusion is performed by weighting posterior probabilities, and thus in the decoding process, a weighting score of decoding posterior probability can be effectively adjusted, so that the explicit decoding processing is more controllable. Because the parameters are easy to control, it is friendlier to engineering.

At operation 303, an intent recognition processing is performed on the predicted audio text to obtain target intent.

In some embodiments, the target intent may be obtained by performing intent recognition processing according to the predicted audio text through a preconfigured intent recognition model, such as an intent recognition model based on deep learning (such as an intent recognition model based on a Transformer structure), a template-based intent recognition model (such as using a predefined template to match user input, and if the predicted audio text matches the template, the corresponding intent may be recognized), etc.

At operation 304, a text generation processing is performed based on the target intention to obtain a reply text.

In some embodiments, the corresponding reply text may be obtained in a pre-configured reply list based on the target intention, or the reply text may be generated dynamically using a Natural-language Generation (NLG) technology, for example, assuming that the predicted audio text is “Hello, how is the weather today?”, the corresponding target intent is that the user wants to know weather conditions. The NLG model may generate a natural reply text based on weather data, user location and time and other information, such as “It's sunny today with a moderate temperature”.

At operation 305, a Text-to-Speech (TTS) processing is performed based on the reply text to obtain a reply audio.

In some embodiments, the TTS processing based on reply text, the reply text may be preprocessed, including word segmentation, part-of-speech tagging, syntactic parsing, etc., to better understand the text content and semantics. The reply text is then converted into a numerical representation, for example, embedding encoding is performed on the reply text to obtain embedding vectors, and a phoneme conversion processing is performed on the embedding vectors to transform the numerical representation of the text into a sequence of phonemes, by using rule-based methods or deep learning models such as LSTM. Subsequently, an acoustic model is employed to convert the sequence of phonemes into a sequence of acoustic features, such as predicting parameters of the sound waveform, such as fundamental frequency (i.e., F0), energy, and timbre. Finally, based on the sequence of acoustic features, a synthesizer converts them into reply audio, which is then used to respond to the user.

Through operations 301 to 305, in a customer service scenario where online training data cannot be obtained, the end-to-end audio recognition method provided by the embodiments of the present disclosure enable the information of the encoder and the information of the decoder to be utilized effectively, where the encoder is responsible for implicit modeling, constructing acoustic information and performing implicit enhancement of the acoustic information, and the decoder performs explicit modeling, and explicit enhancement of the information of the decoder at a semantic level, which improves the word recall ability in an unknown scenario, and enhances the capture of specific words, so that the customer's intent is better understood for automatic customer reply, thereby achieving a beneficial effect of enhancing customer satisfaction.

The following will continue to describe an exemplary structure in which the audio recognition apparatus 433 provided by the embodiments of the present disclosure is implemented as software modules. In some embodiments, as illustrated in FIG. 2, the software modules stored in the audio recognition apparatus 433 of the memory 130 may include a data processing module 4331 and a prediction module 4332.

The data processing module 4331 is configured to encode audio data to an audio encoding feature.

In some embodiments, the data processing module 4331 is further configured to decode the audio encoding feature to a first decoded feature.

In some embodiments, the data processing module 4331 is further configured to encode a preset word text and the first decoded feature to a first text encoding feature, where the first text encoding feature includes a feature representing semantics of the preset word text and a feature representing semantics of the audio data.

The prediction module 4332 is configured to decode the first text encoding feature to a predicted audio text, where the predicted audio text represents the semantics of the preset word text and the semantics of the audio data.

In some embodiments, the data processing module 4331 is further configured to: determine a first attention feature based on the preset word text and the first decoded feature, where the first attention feature represents attention weights for respective words in the preset word text, and the attention weights are proportional to probability values of the respective words being key words; and fuse the first attention feature and the first decoded feature to obtain the first text encoding feature.

In some embodiments, the data processing module 4331 is further configured to: perform a context encoding processing on the word text to obtain a first contextual word feature vector; and process, by using an attention mechanism, on the first contextual word feature vector and the first decoded feature to obtain the first attention feature.

In some embodiments, the data processing module 4331 is further configured to: determine an attention weight based on the first contextual word feature vector and the first decoded feature; and weight the first contextual word feature vector by using the attention weight to obtain the first attention feature.

In some embodiments, the data processing module 4331 is further configured to: encode the word text and the audio encoding feature to obtain a second text encoding feature; and fuse the second text encoding feature and the audio encoding feature to obtain a new audio encoding feature, where the new audio encoding feature is used for obtaining the first decoded feature after decoding.

In some embodiments, the data processing module 4331 is further configured to: perform a context encoding processing on the word text to obtain second contextual word feature vector; process, by using an attention mechanism, on the second contextual word feature vector and the first decoded feature to obtain a second attention feature; and fuse the second attention feature and the first decoded feature to obtain the second text encoding feature.

In some embodiments, the data processing module 4331 is further configured to: encode an audio data sample to a first audio sample encoding feature through an encoder in an initial audio recognition model; determine a first loss value based on the first audio sample encoding feature and an audio text annotation corresponding to the audio data sample; decode the first audio sample encoding feature to a first sample decoded feature through a decoder in the initial audio recognition model; determine a second loss value based on the first sample decoded feature and the audio text annotation; and combine the first loss value and the second loss value to obtain a combined loss value, and update parameters of the encoder and the decoder based on the combined loss value to obtain a first audio recognition model.

In some embodiments, the data processing module 4331 is further configured to: add a first word enhancement network to the first audio recognition model to obtain a new first audio recognition model; acquire a first word sample from the audio text annotation, and encode the first word sample and an output of an encoder in the new first audio recognition model to a second sample encoding feature through the first word enhancement network; the second sample encoding feature is decoded to a first predicted word through the first word enhancement network; and determine a third loss value based on the first predicted word and a preset word label, and update parameters of the first word enhancement network added in the new first audio recognition model based on the third loss value to obtain a second audio recognition model.

In some embodiments, the data processing module 4331 is further configured to: determine an initial position where the audio text annotation is sampled, and perform a sampling processing on a text located after the initial position in the audio text annotation to obtain a sampled text; when a count of characters in the sampled text is within a character count range and the sampled text is included in the word label, determine the sampled text as a positive sample; when the count of characters in the sampled text is within the character count range and the sampled text is not included in the word label, determine the sampled text as a negative sample; and determine the positive sample and the negative sample as the first word sample.

In some embodiments, the data processing module 4331 is further configured to: perform a context encoding processing on the first word sample to obtain a third contextual word feature vector; process, by using an attention mechanism, the third contextual word feature vector and the output of the encoder in the new first audio recognition model to obtain a third attention feature; and fuse the third attention feature and the output of the encoder in the new first audio recognition model to obtain the second sample encoding feature.

In some embodiments, the data processing module 4331 is further configured to: add a second word enhancement network to the second audio recognition model to obtain a new second audio recognition model; acquire a second word sample from the audio text annotation, and encode the second word sample and an output of a decoder in the new second audio recognition model to a first sample encoding feature through the second word enhancement network; decode the first sample encoding feature to a predicted audio sample text; and update parameters of the new second audio recognition model based on an output of the first word enhancement network in the new second audio recognition model, the preset word label, the predicted audio sample text, and the audio text annotation, to obtain a third audio recognition model.

In some embodiments, the data processing module 4331 is further configured to: determine a fourth loss value based on the output of the first word enhancement network in the new second audio recognition model and the preset word label; determine a fifth loss value based on the predicted audio sample text and the audio text annotation; and update parameters of the first word enhancement network in the new second audio recognition model based on the fourth loss value and updating parameters of the second word enhancement network added in the new second audio recognition model based on the fifth loss value, to obtain the third audio recognition model.

Embodiments of the present disclosure provide a computer program product, including computer programs or computer-executable instructions, where the computer programs or computer-executable instructions are stored in a computer-readable storage medium. A processor of an electronic device reads the computer-executable instructions from the computer-readable storage medium, and the processor executes the computer-executable instructions to cause the electronic device to execute the above audio recognition method described in the embodiments of the present disclosure.

Embodiments of the present disclosure provide a computer-readable storage medium storing computer-executable instructions or computer programs. When executed by a processor, the computer-executable instructions or the computer programs will cause the processor to perform the audio recognition method provided by the embodiments of the present disclosure, such as the audio recognition method illustrated in FIG. 3A.

In some embodiments, the computer-readable storage medium may be a memory such as a RAM, a ROM, a flash memory, a magnetic surface memory, an optical disc, or a CD-ROM. The computer-readable storage medium may also be a variety of devices including one or any combination of the above memories.

In some embodiments, the computer-executable instructions may take the form of programs, software, software modules, scripts, or code, written in any programming language (including compiled or interpreted languages, or declarative or procedural languages). These instructions may be deployed in any form, including as standalone programs or as modules, components, subroutines, or other units suitable for use in a computing environment.

As an example, the computer-executable instructions may, but do not necessarily correspond to files in a file system, or may be stored as part of a file saving other programs or data, e.g., in one or more scripts of a Hyper Text Markup Language (HTML) document, in a single file dedicated to the programs in question, or in multiple collaborative files (e.g., files storing one or more modules, subroutines, or portions of code).

As an example, the computer-executable instructions may be deployed on an electronic device for execution, or on a plurality of electronic devices located at a location, or on a plurality of electronic devices distributed over a plurality of locations and interconnected by a communication network.

In summary, according to the embodiments of the present disclosure, the first decoded feature is obtained from the audio data, the preset word text and the first decoded feature are encoded to the first text encoding feature, and the first text encoding feature is decoded to the predicted audio text. Compared with a manner of performing audio recognition simply based on the audio data of an input text in related art, in the proposed approach, by encoding the preset word text and the first decoded feature in the decoding stage before decoding and outputting, the semantics of the audio data can be characterized sufficiently in scenarios requiring specific word recognition, thereby improving the accuracy of the audio text obtained based on the first text encoding feature.

What described are merely embodiments of the present disclosure, and are not intended to limit the present disclosure. All modifications, replacements and improvements made within the spirit and ranges of the present disclosure should be included within the scope of protection of the present disclosure.

1. A method for audio recognition, comprising:
encoding audio data to a first audio encoding feature;
decoding the first audio encoding feature to a first decoded feature;
encoding a preset word text and the first decoded feature to a first text encoding feature, wherein the first text encoding feature comprises a feature representing semantics of the preset word text and a feature representing semantics of the audio data; and
decoding the first text encoding feature to a predicted audio text, wherein the predicted audio text represents the semantics of the preset word text and the semantics of the audio data.

2. The method of claim 1, wherein encoding the preset word text and the first decoded feature to the first text encoding feature comprises:
determining a first attention feature based on the preset word text and the first decoded feature, wherein the first attention feature represents attention weights for respective words in the preset word text; and
fusing the first attention feature and the first decoded feature to obtain the first text encoding feature.

3. The method of claim 2, wherein determining the first attention feature based on the preset word text and the first decoded feature comprises:
performing a context encoding processing on the preset word text to obtain a first contextual word feature vector; and
processing, by using an attention mechanism, the first contextual word feature vector and the first decoded feature to obtain the first attention feature.

4. The method of claim 3, wherein processing, by using the attention mechanism, the first contextual word feature vector and the first decoded feature to obtain the first attention feature comprises:
determining an attention weight based on the first contextual word feature vector and the first decoded feature; and
weighting, by using the attention weight, the first contextual word feature vector to obtain the first attention feature.

5. The method of claim 1, wherein before decoding the first audio encoding feature to the first decoded feature, the method further comprises:
encoding the preset word text and the first audio encoding feature to a second text encoding feature; and
fusing the second text encoding feature and the first audio encoding feature to obtain a second audio encoding feature.

6. The method of claim 5, wherein encoding the preset word text and the first audio encoding feature to the second text encoding feature comprises:
performing a context encoding processing on the preset word text to obtain a second contextual word feature vector;
processing, by using an attention mechanism, the second contextual word feature vector and the first decoded feature to obtain a second attention feature; and
fusing the second attention feature and the first decoded feature to obtain the second text encoding feature.

7. The method of claim 1, wherein the method for audio recognition is implemented through an audio recognition model, and before encoding the audio data to the first audio encoding feature, the method further comprises:
encoding, through an encoder in an initial audio recognition model, an audio data sample to a first audio sample encoding feature;
determining a first loss value based on the first audio sample encoding feature and an audio text annotation corresponding to the audio data sample;
decoding, through a decoder in the initial audio recognition model, the first audio sample encoding feature to a first sample decoded feature;
determining a second loss value based on the first sample decoded feature and the audio text annotation; and
combining the first loss value and the second loss value to obtain a combined loss value, and updating parameters of the encoder and the decoder based on the combined loss value to obtain a first audio recognition model.

8. The method of claim 7, wherein after obtaining the first audio recognition model, the method further comprises:
adding a first word enhancement network to the first audio recognition model to obtain a new first audio recognition model;
acquiring a first word sample from the audio text annotation, and encoding, through the first word enhancement network, the first word sample and an output of an encoder in the new first audio recognition model to a second sample encoding feature;
decoding, through the first word enhancement network, the second sample encoding feature to a first predicted word; and
determining a third loss value based on the first predicted word and a preset word label, and updating parameters of the first word enhancement network added in the new first audio recognition model based on the third loss value to obtain a second audio recognition model.

9. The method of claim 8, wherein acquiring the first word sample from the audio text annotation comprises:
determining an initial position where the audio text annotation is sampled, and performing a sampling processing on a text located after the initial position in the audio text annotation to obtain a sampled text;
when a count of characters in the sampled text is within a character count range and the sampled text is comprised in the preset word label, determining the sampled text as a positive sample; when the count of characters in the sampled text is within the character count range and the sampled text is not comprised in the preset word label, determining the sampled text as a negative sample; and
determining the positive sample and the negative sample as the first word sample.

10. The method of claim 8, wherein encoding the first word sample and the output of the encoder in the new first audio recognition model to the second sample encoding feature comprises:
performing a context encoding processing on the first word sample to obtain a third contextual word feature vector;
processing, by using an attention mechanism, the third contextual word feature vector and the output of the encoder in the new first audio recognition model to obtain a third attention feature; and
fusing the third attention feature and the output of the encoder in the new first audio recognition model to obtain the second sample encoding feature.

11. The method of claim 8, wherein after obtaining the second audio recognition model, the method further comprises:
adding a second word enhancement network to the second audio recognition model to obtain a new second audio recognition model;
acquiring a second word sample from the audio text annotation, and encoding, through the second word enhancement network, the second word sample and an output of a decoder in the new second audio recognition model to a first sample encoding feature;
decoding the first sample encoding feature to a predicted audio sample text; and
updating parameters of the new second audio recognition model based on an output of the first word enhancement network in the new second audio recognition model, the preset word label, the predicted audio sample text, and the audio text annotation, to obtain a third audio recognition model.

12. The method of claim 11, wherein updating the parameters of the new second audio recognition model based on the output of the first word enhancement network in the new second audio recognition model, the preset word label, the predicted audio sample text, and the audio text annotation, to obtain the third audio recognition model comprises:
determining a fourth loss value based on the output of the first word enhancement network in the new second audio recognition model and the preset word label;
determining a fifth loss value based on the predicted audio sample text and the audio text annotation; and
updating parameters of the first word enhancement network in the new second audio recognition model based on the fourth loss value and updating parameters of the second word enhancement network added in the new second audio recognition model based on the fifth loss value, to obtain the third audio recognition model.

13. An apparatus for audio recognition, comprising:
a processor, and a memory configured to store computer-executable instructions or computer programs, wherein the processor is configured to execute the computer-executable instructions or computer programs to:
encode audio data to a first audio encoding feature;
decode the first audio encoding feature to a first decoded feature; and
encode a preset word text and the first decoded feature to a first text encoding feature, wherein the first text encoding feature comprises a feature representing semantics of the preset word text and a feature representing semantics of the audio data; and
decode the first text encoding feature to a predicted audio text, wherein the predicted audio text represents the semantics of the preset word text and the semantics of the audio data.

14. The apparatus of claim 13, wherein the processor is specifically configured to execute the computer-executable instructions or computer programs to:
determine a first attention feature based on the preset word text and the first decoded feature, wherein the first attention feature represents attention weights for respective words in the preset word text; and
fuse the first attention feature and the first decoded feature to obtain the first text encoding feature.

15. The apparatus of claim 14, wherein the processor is specifically configured to execute the computer-executable instructions or computer programs to:
perform a context encoding processing on the preset word text to obtain a first contextual word feature vector; and
process, by using an attention mechanism, the first contextual word feature vector and the first decoded feature to obtain the first attention feature.

16. The apparatus of claim 15, wherein the processor is specifically configured to execute the computer-executable instructions or computer programs to:
determine an attention weight based on the first contextual word feature vector and the first decoded feature; and
weight, by using the attention weight, the first contextual word feature vector to obtain the first attention feature.

17. The apparatus of claim 13, wherein the processor is specifically configured to execute the computer-executable instructions or computer programs to: before decoding the first audio encoding feature to the first decoded feature,
encoding the preset word text and the first audio encoding feature to a second text encoding feature; and
fuse the second text encoding feature and the first audio encoding feature to obtain a second audio encoding feature.

18. The apparatus of claim 17, wherein the processor is specifically configured to execute the computer-executable instructions or computer programs to:
encode the preset word text to a second contextual word feature vector;
process, by using an attention mechanism, the second contextual word feature vector and the first decoded feature to obtain a second attention feature; and
fuse the second attention feature and the first decoded feature to obtain the second text encoding feature.

19. The apparatus of claim 13, wherein the processor is specifically configured to execute the computer-executable instructions or computer programs to: before encoding the audio data to the first audio encoding feature,
encode, through an encoder in an initial audio recognition model, an audio data sample to a first audio sample encoding feature;
determine a first loss value based on the first audio sample encoding feature and an audio text annotation corresponding to the audio data sample;
decode, through a decoder in the initial audio recognition model, the first audio sample encoding feature to a first sample decoded feature;
determine a second loss value based on the first sample decoded feature and the audio text annotation; and
combine the first loss value and the second loss value to obtain a combined loss value, and update parameters of the encoder and the decoder based on the combined loss value to obtain a first audio recognition model.

20. A non-transitory computer-readable storage medium, storing computer-executable instructions or computer programs, wherein the computer-executable instructions or computer programs, when executed by a processor, implement the following operations:
encoding audio data to a first audio encoding feature;
decoding the first audio encoding feature to a first decoded feature;
encoding a preset word text and the first decoded feature to a first text encoding feature, wherein the first text encoding feature comprises a feature representing semantics of the preset word text and a feature representing semantics of the audio data; and
decoding the first text encoding feature to a predicted audio text, wherein the predicted audio text represents the semantics of the preset word text and the semantics of the audio data.
